(19) United States
(12) Patent Application Publication
(10) Pub. No.: US 2015/0178046 A1
(43) Pub. Date: Jun. 25, 2015

(54) CONTACT MANAGEMENT SYSTEM LEARNING FROM MESSAGE EXCHANGE PATTERNS, POSITIONAL INFORMATION OR CALENDAR

(71) Applicant: BHI Inc., Tokyo (JP)

(72) Inventor: Yasuhiro HIMUKASHI, Tokyo (JP)

(21) Appl. No.: 14/476,505

(22) Filed: Sep. 3, 2014

Related U.S. Application Data
(60) Provisional application No. 61/918,146, filed on Dec. 19, 2013.

(51) Int. Cl. G06F 7/36; G06N 99/00; G06F 17/30

(52) U.S. Cl. CPC G06F 7/36; G06F 17/30705; G06N 99/005

(57) ABSTRACT

A contact management system learning from messages, positional information or a calendar is provided. The contact management system includes a data acquisition unit that obtains various sorts of communication data and information on the position of a user terminal from a plurality of external services, a distributive integral database that integrates the communication data obtained by the data acquisition unit, and distributes the data with respect to contacts, a priority determination unit that determines priorities by learning the communication data accumulated in the distributive integral database, and an application unit that presents information according to the priorities determined by the priority determination unit. The contact management system displays only contacts with higher priorities on a display screen of the user terminal.

### INCORPORATION BY REFERENCE

The present application claims priority from U.S. provisional patent application No. 61/918,146 filed on Dec. 19, 2013, the content of which is hereby incorporated by reference into this application.

### BACKGROUND OF THE INVENTION

The present invention relates to a contact management system and, more particularly, to a contact management system learning from messages, positional information or a calendar.

With the expansion of variety of information terminals and information services in recent years, users have come to communicate with others by using a plurality of communication tools.

In communication using a conventional communication tool such as a mailer, a messenger or a telephone application, information is dispersedly provided with respect to communication services and large amounts of dispersed information are accumulated. With this communication, therefore, there is a problem that it takes much time for a user to obtain necessary information at a certain time and place.

A system provided as a solution to this problem is known. For example, U.S. Pat. No. 8,526,969 discloses a system in which an alert is issued when a contact having a frequency of interaction with a user in the past and a context meeting a certain standard exists near the user.

The invention disclosed in U.S. Pat. No. 8,526,969, however, only informs a user of the existence of a nearby contact, not eliminating the inconvenient effect of issuing an alert even when there is no need for communication with the nearby contact. This invention also has a problem in that even when there is a need for communication between a user and a contact, no alert is issued if the contact is not near the user.

Thus, the related art is incapable of eliminating the inconvenience of handling information accumulated in an unnecessarily large amount or information of small importance, which means a hindrance to user's concentration on essentially necessary communication at a certain time and place.

### SUMMARY OF THE INVENTION

A system capable of narrowing down contacts in an optimum way according to conditions in terms of time and place and presenting the contacts to a user to enable the user to speedily grasp and select necessary communication at a certain time and place is in demand as a solution to the above-described problem. Accordingly, there is a need to provide a system capable of integrating and learning communications performed in a plurality of services and narrowing down contacts in an optimum way at a certain time and place.

The present invention provides, as a solution to the above-described problem, a contact management system which effectively presents information useful at a certain time and place from communication information obtained from a plurality of external services.

Further, according to the present invention, communication information is obtained from a plurality of external services and distributed and integrated, and filtering, sorting and learning are performed on the communication data distributed and integrated. As a result of learning, priorities for contacts are determined A contact with a higher priority is displayed at a higher position in an inbox, while a contact with a lower priority is displayed at a lower position in the inbox.

According to a second aspect of the present invention, a contact list is displayed in priority order.

According to a third aspect of the present invention, a schedule list is displayed in order from the nearest date or in priority order.

Further, the contact management system according to the present invention includes a data acquisition unit that obtains various sorts of communication data from a plurality of external services, a distributive integral database that integrates the communication data obtained by the data acquisition unit and distributes the data with respect to contacts, a priority determination unit that determines priorities by learning the communication data accumulated in the distributive integral database, and an application unit that presents information according to the priorities determined by the priority determination unit.

The application unit further includes an inbox preparation unit, a contact list preparation unit and a schedule list preparation unit.

A contact management server has a data acquisition unit that obtains various sorts of communication data from a plurality of external services, a distributive integral database that integrates the communication data obtained by the data acquisition unit and distributes the data with respect to contacts, and a priority determination unit that determines priorities by learning the communication data accumulated in the distributive integral database.

The data acquisition unit obtains, from a plurality of external services, communication data transmitted and received in the plurality of external services. The communication data transmitted and received in the plurality of external services are typically messages, a telephone history, calendar information, a plan table, transmission dates, reception dates, transmission places and reception places. The message may include a message based on characters, a message based on sound, a message based on an image, and a message using a combination of these kinds of message. The communication data may include any other sorts of information about communications.

The data acquisition unit also obtains addresses for persons who made communications included in the communication data and stores the addresses in the distributive integral database. Addresses may be obtained from an address book stored in a user terminal such as a portable telephone, a smartphone or a personal computer (PC) and stored.

The data acquisition unit may obtain, from a plurality of external services, through a real-time receiving unit, communication data transmitted and received in the plurality of external services. The real-time receiving unit receives communication data in real time from the plurality of external services and transmits the communication data to the data acquisition unit.

The distributive integral database integrates the communication data from the plurality of external services obtained by the data acquisition unit and stores the integrated communication data.

The communication data from the plurality of external services is stored in the distributive integral database while being distributed with respect to contacts.

The priority determination unit determines priorities for contacts on the basis of the communication data stored in the distributive integral database. Priorities for contacts are determined, for example, on the basis of the frequencies of communication between the user and persons as contacts, time periods taken for communications and places of communication. The priority for each contact is increased if the frequency of communication is higher and if the communication time is longer. The priority for each contact is also changed depending on the current location of the user. For example, when the user is in a region A, the priority for the contact with which the user communicated frequently in the past is increased.

The application unit presents information on the user terminal on the basis of the priorities determined by the priority determination unit. The application unit includes at least one of the inbox preparation unit, the contact list preparation unit and the schedule list preparation unit. The application unit further includes a user input unit for accepting an input from the user.

The inbox preparation unit displays a predetermined number of contacts with higher priorities in the inbox on the display screen of the user terminal. Preferably, the predetermined number is, for example, a small number about 10 as a result of narrowing down. However, the predetermined number is not limited to this. The inbox preparation unit displays a contact with a higher priority at a higher position in the inbox on the display screen of the user terminal, and displays a contact with a lower priority at a lower position in the inbox.

The contact list preparation unit displays a predetermined number of contacts with higher priorities in the contact list on the display screen of the user terminal. Preferably, the predetermined number is, for example, a small number about 10 as a result of narrowing down. However, the predetermined number is not limited to this.

The contact list preparation unit displays a contact with a higher priority at a higher position in the contact list on the display screen of the user terminal, and displays a contact with a lower priority at a lower position in the contact list.

The schedule list preparation unit displays a predetermined number of plans in the schedule list on the display screen of the user terminal. Preferably, the predetermined number is, for example, a small number about 10 as a result of narrowing down. However, the predetermined number is not limited to this.

The schedule list preparation unit extracts a plan obtained from the plurality of external services in the communication data obtained from the plurality of external services and stored in the distributive integral database, and displays a predetermined number of plans in order from the nearest plan date.

The schedule list preparation unit may display a plan with a higher priority at a higher position in the schedule list on the display screen of the user terminal and display a plan with a lower priority at a lower position in the schedule list.

A new data preparation unit prepares new data on the basis of user input data received from the application unit.

The new data preparation unit receives, from the application unit, messages, telephone calls and plans to the external services, and transmits the messages, telephone calls and plans to the external services. The new data preparation unit receives a request for integration of positional information, new contacts and contacts from the application unit, and transmits the request to the external services. The new data preparation unit also records messages a telephone call history, plans, positional information and new contacts in the distributive integral database. The new data preparation unit performs integration of contacts in the distributive integral database according to a request for integration of the contacts.

A new data transmitting unit receives new data from the new data preparation unit and transmits the new data to the external services.

According to the present invention, information useful at a certain time and place can be effectively presented from communication information obtained from a plurality of external services.

Other objects, features and advantages of the invention will become apparent from the following description of the embodiments of the invention taken in conjunction with the accompanying drawings.

### BRIEF DESCRIPTION OF THE DRAWINGS

FIG. 1 is a diagram showing an outline of a contact management system according to an embodiment of the present invention;

FIG. 2 is a diagram showing the relationship between a contact management server and an application unit according to the present invention and user terminals;

FIG. 3 is a diagram showing the flow of processing in the contact management system according to the present invention;

FIG. 4 is a diagram showing the flow of processing in a priority determination unit;

FIG. 5 is a diagram showing the flow of inbox preparation processing;

FIG. 6 is a diagram showing the flow of contact list preparation processing;

FIG. 7 is a diagram showing the flow of schedule list preparation processing; and

FIG. 8 is a diagram showing the flow of learning processing in priority determination unit 6.

### DESCRIPTION OF THE EMBODIMENTS

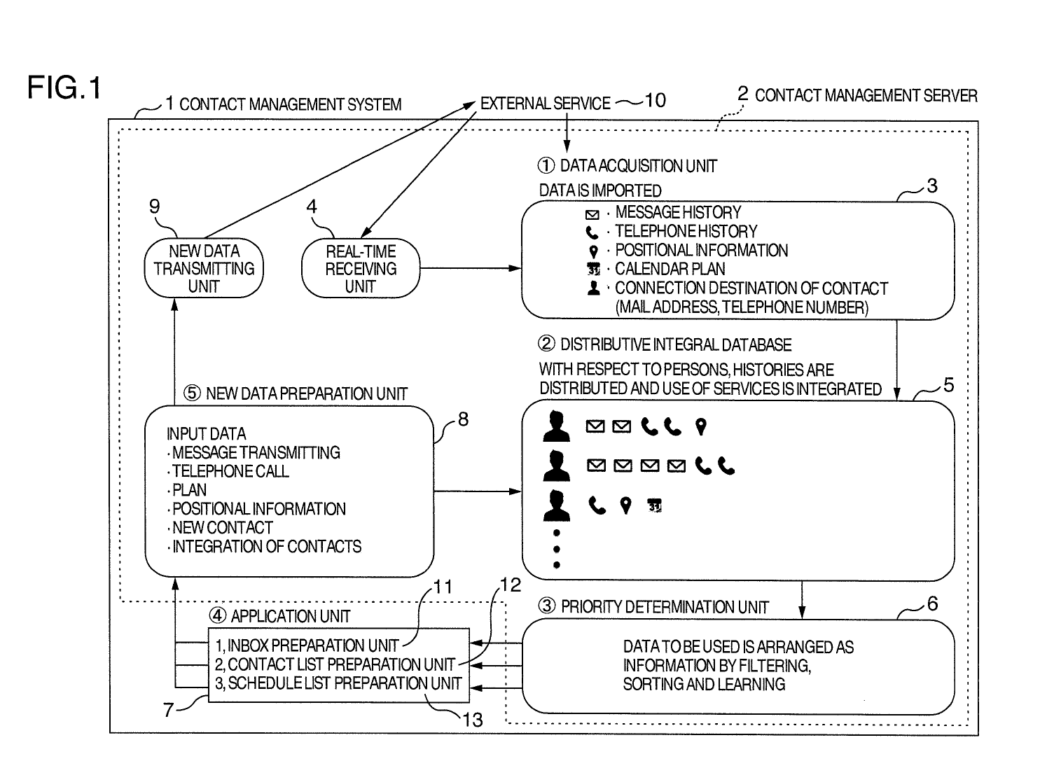

FIG. 1 is a diagram showing an outline of a contact management system according to an embodiment of the present invention. A contact management system 1 includes a contact management server 2 and an application unit 7.

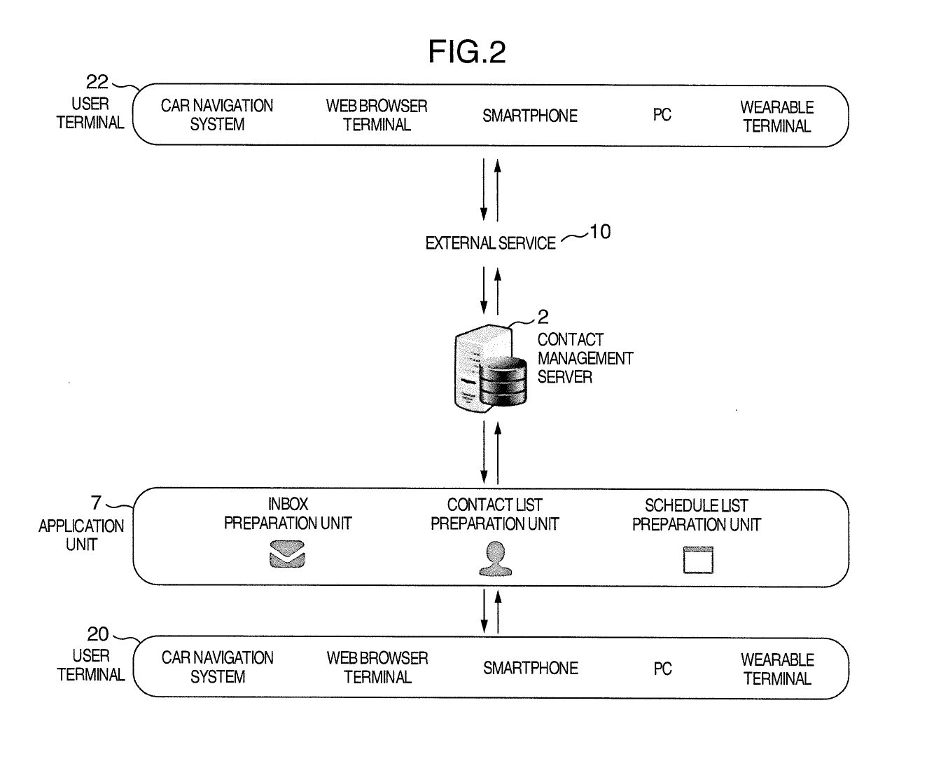

FIG. 2 is a diagram showing the relationship between the contact management server 2 and application unit 7 of the present invention and user terminals 20 and 22.

The contact management server 2 performs transmission and reception of communication data between itself and an external service 10. The contact management server 2 also performs transmission and reception of communication data between itself and the application unit 7. The user terminal 20 exchanges communication data with the application unit 7. The application unit 7 is installed in the user terminal 20 or connected to the user terminal 20 wirelessly or by a cable.

The user terminal 22 is a user terminal in which the application unit 7 is not installed or which is not directly connected to the application unit 7. The user terminal 22 performs transmission and reception of communication data between itself and the external service 10. The application unit 7 can obtain communication data on the user terminal 22 through the contact management server 2 and the external service 10.

Transmission and reception of communication data are performed typically by a public communication network such as the Internet. However, such a network is not exclusively used. Transmission and reception of communication data may be performed through a short-distance communication network.

Each of the user terminals 20 and 22 used by users may be any of various kinds of terminals, such as a car navigation device, a Web browser terminal, a smart phone, a personal computer (PC) and a wearable terminal.

The contact management server 2 may include a data acquisition unit 3, a distributive integral database 5, a priority determination unit 6, and a new data preparation unit 8. The contact management server 2 may further include a real-time receiving unit 4 and a new data transmitting unit 9.

The data acquisition unit 3 obtains communication data from a plurality of external services 10. The communication data includes messages, such as e-mail messages, voice mail messages and SNS messages, message histories, telephone histories, positional information, calendar schedules, and contact contacts, such as e-mail addresses and telephone numbers. The data acquisition unit 3 obtains, by import, communication data stored in the external services.

The data acquisition unit 3 may obtain communication data from the external service 10 in real time through the real-time receiving unit 4. The real-time receiving unit 4 obtains communication data from the external service 10 and transmits the communication data to the data acquisition unit 3.

The distributive integral database 5 stores communication data obtained through the data acquisition unit 3 by distributing and integrating the communication data. The communication data is distributed with respect to contacts and a plurality of sorts of communication data are integrated with respect to each of the contacts.

The priority determination unit 6 filters, sorts and learns communication data stored in the distributive integral database 5, sorts out data to be used, and determines priorities for contacts. Priorities for contacts are determined, for example, on the basis of frequencies of communication between users and contacts, amounts of communication time, places of communication, communication time periods, information on the positions of user terminals.

A frequency of communication represents a frequency with which communication is performed between a user and a contact. A frequency of communication is computed on the basis of the number of times communication data was transmitted and received between a user and a contact during a certain time period. For example, the number of times transmission and reception of messages or telephonic communication was performed between a user and a contact in a month may be computed. The certain time period is not limited to one month. Any time period, e.g., a certain number of days, one week, a certain number of weeks, one year or a certain number of years may be set as the certain time period.

An amount of communication time represents a length of time during which communication is performed between a user and a contact. An amount of communication time may be the sum of time periods taken for communications between a user and a contact or the average of time periods taken for communications over a certain time period. For example, in a case where communication data is a telephone history, an amount of communication time may be the sum or average of telephonic communication times. Also, an amount of communication time may be the sum or average of time periods during which a user had a meeting with a contact.

A place of communication represents a place where the user terminal 20 was located when communication was performed between a user and a contact, or a place where a contact terminal was located. For example, a place of communication may be places where the user terminal 20 and a contact terminal were respectively located when a user performed transmission and reception of messages or telephonic communication between him/herself and the contact. Also, a place relating to a user or a contact, e.g., a user's place of employment or a place of employment at the contact, the address of a user's home or a place for meeting may be registered in advance, thereby enabling determination of the relationship between the user and the contact, for example, according to whether the place where communication was performed was the user's place of employment, the place of employment at the contact, or the user's home.

A communication day in week represents a day of the week on which a user performed communication between the user and a contact. For example, a communication day in week may be one of Monday, Tuesday, Wednesday, Thursday, Friday, Saturday and Sunday, a weekday, a holiday or a festival day. Not only holidays based on a calendar but also holidays for a user or a contact, i.e., non-working days, may be set in advance by a user's input operation, thereby enabling determination as to whether a communication between the user and the contact was performed on a holiday or a working day.

A communication time period represents a time period during which a user performed communication between the user and a contact. A communication time period may be, for example, one of particular time periods divided at intervals of one hour or several hours or a time period defined as a time period in the forenoon, the afternoon or the night, an early time in the morning, or the like. User's working hours or working hours at the contact may be set in advance as a communication time period by a user's input operation, thereby enabling determination as to whether a communication between the user and the contact was performed in a working time period or in a free time.

Information on the position of the user terminal is obtained at all times or periodically apart from a place of communication. A GPS function of the user terminal is used to obtain positional information.

The priority determination unit 6 has a learning function to analyze various sorts of information to be used for determination of priorities from histories of past communication data and information on the positions of user terminals.

The priority determination unit 6 determines a user's daily lifestyle by analyzing past communication data and a history of information on the position of the user terminal. For example, a place where a user spends a long time in the daytime can be determined from a history of information on the position of the user terminal. As such a place, a school in the case of a student or a place of work in the case of a business person may be determined. On the other hand, one's home may be determined as a place where a user spends a long time from an earlier time in the night to midnight or to an early time in the morning.

The priority determination unit 6 determines the relationship between a user and a contact by analyzing a history of past communication data. For example, in a case where a certain place is determined as a place of work in lifestyle determination with respect to a user, a contact can be determined as a user's colleague if it has spent a long time in the same place in the daytime. On the other hand, in a case where a certain place is determined as a user's home, a contact can be determined as a person in the user's family if it has spent a long time in the same place. Also, a contact existing in the same place other than a user's place of work and home and in the same time period on the same day of the week as a user can be determined as belonging to the same hobby circle, working group, ad hoc project team or the like as one to which the user belongs.

The priority determination unit 6 can also determine whether or not a user and a contact are performing face-to-face communication from a history of information on the position of the user terminal and a history of information on the position of the contact terminal. In a case where the user terminal and the contact terminal have been held at a small distance from each other during a certain time period, it is possible to determine that face-to-face communication has been performed between the user and the contact.

The priority determination unit 6 can determine a certain action or a communication as a usual action or an unusual action from a history of past communication data and a history of information on the position of the user terminal. In a case where a certain action or a communication is determined as an unusual action, communication data or positional information about unusual actions may be removed, if necessary, from learning data used for the above-described determination of a lifestyle, determination of a relationship and determination of face-to-face communication.

The application unit 7 displays information on the user terminal 20 on the basis of a priority determined by the priority determination unit 6. The application unit 7 includes at least one of an inbox preparation unit 11, a contact list preparation unit 12 and a schedule list preparation unit 13.

The inbox preparation unit 11 displays, typically on a display screen of the user terminal 20, a contact with a higher priority at a higher position in an inbox, and a contact with a lower priority at a lower position in the inbox. That is, contacts are displayed in decreasing order of priority on the display screen of the user terminal 20. For example, only contacts with priorities equal to or higher than the tenth priority may be displayed in the inbox. The inbox preparation unit 11 may display only contacts with higher priorities or a contact with the highest priority in the inbox. As contacts with higher priorities in such a case, contacts with priorities equal to or higher than a certain priority may be displayed. Also, the inbox preparation unit 11 may divide contacts into a plurality of ranks according to the degree of priority, set part of the ranks higher than a certain one of the ranks as ranks with higher priorities, and display only the higher part of the ranks in the inbox.

Also, the inbox preparation unit 11 may display contacts in such a manner that contacts with lower priorities or a contact with the lowest priority is not displayed in the inbox. As contacts with lower priorities in such a case, contacts with priorities equal to or lower than a certain priority may be not displayed. Also, the inbox preparation unit 11 may divide contacts into a plurality of ranks according to the degree of priority, set part of the ranks lower than a certain one of the ranks as ranks with lower priorities, and not display only the lower part of the ranks in the inbox. The inbox preparation unit 11 may display, in priority order or date order, only contacts selected by filtering out contacts with which no exchange was made before a certain past time period, e.g., one week from those in the history over the past time period.

The contact list preparation unit 12 displays, typically on the display screen of the user terminal 20, a contact with a higher priority at a higher position in a contact list, and a contact with a lower priority at a lower position in the contact list. That is, contacts are displayed in decreasing order of priority on the display screen of the user terminal 20. For example, only contacts with priorities equal to or higher than the tenth priority may be displayed in the contact list. The contact list preparation unit 12 may display only contacts with higher priorities or a contact with the highest priority in the contact list. As contacts with higher priorities in such a case, contacts with priorities equal to or higher than a certain priority may be displayed. Also, the contact list preparation unit 12 may divide contacts into a plurality of ranks according to the degree of priority, set part of the ranks higher than a certain one of the ranks as ranks with higher priorities, and display only the higher part of the ranks in the contact list.

Also, the contact list preparation unit 12 may display contacts in such a manner that contacts with lower priorities or a contact with the lowest priority is not displayed in the contact list. As contacts with lower priorities in such a case, contacts with priorities equal to or lower than a certain priority may be not displayed. Also, the contact list preparation unit 12 may divide contacts into a plurality of ranks according to the degree of priority, set part of the ranks lower than a certain one of the ranks as ranks with lower priorities, and not display only the lower part of the ranks in the contact list.

The contact list preparation unit 12 may divide contacts into groups related to initials A to Z of names of the contacts and display the contacts in decreasing order of priority in the contact list with respect to each of alphabetical characters for the divisions.

The schedule list preparation unit 13 extracts plans obtained from the plurality of external services 10 in communication data obtained from the external services 10 and stored in the distributive integral database 5, and displays the plans in order from the nearest one. The schedule list preparation unit 13 may display, in priority order or date order, only contacts selected by filtering out contacts with which no exchange was made in the past from those in future plans in a certain time period, e.g., one week.

The schedule list preparation unit 13 displays, on the display screen of the user terminal 20, a plan with a higher priority at a higher position in a schedule list, and a plan with a lower priority at a lower position in the schedule list. In this case, the schedule list is displayed in decreasing order of priority on the display screen of the user terminal 20. For example, only plans with priorities equal to or higher than the tenth priority may be displayed in the schedule list. The schedule list preparation unit 13 may display only plans with higher priorities or a plan with the highest priority in the schedule list. As plans with higher priorities in such a case, plans with priorities equal to or higher than a certain priority may be displayed. Also, the schedule list preparation unit 13 may divide plans into a plurality of ranks according to the degree of priority, set part of the ranks higher than a certain one of the ranks as ranks with higher priorities, and display only the higher part of the ranks in the schedule list.

Also, the schedule list preparation unit 13 may display plans in such a manner that plans with lower priorities or a plan with the lowest priority is not displayed in the schedule list. As plans with lower priorities in such a case, plans with priorities equal to or lower than a certain priority may be not displayed. Also, the schedule list preparation unit 13 may divide plans into a plurality of ranks according to the degree of priority, set part of the ranks lower than a certain one of the ranks as ranks with lower priorities, and not display only the lower part of the ranks in the schedule list.

The schedule list preparation unit 13 may display a plan relating to a contact with a higher priority at a higher position in the schedule list, and a plan relating to a contact with a lower priority at a lower position in the schedule list. For example, the schedule list preparation unit 13 may display in the schedule list only plans relating to contacts with higher priorities displayed by the inbox preparation unit or the contact list preparation unit.

The inbox preparation unit 11 may display only contacts relating to the nearest plan in the inbox, or may display contacts in the inbox in order from the nearest plan to meet.

The inbox preparation unit 11 may display only pieces of mail or messages for which no replies have been made in pieces of mail or messages with higher priorities. The inbox preparation unit 11 may set a certain number of contacts to be displayed as contacts with higher priorities and display only the set number of contacts with higher priorities. The set number may be smaller than the ordinary displayed number. For example, only three contacts with higher priorities may be displayed at a certain time in a certain situation.

The contact list preparation unit 12 may display only contacts relating to the nearest plan in the contact list, or may display contacts in the inbox in order from the nearest plan to meet.

The schedule list preparation unit 13 may display a destination according to the nearest plan. A destination according to the nearest plan may be indicated, for example, by a name and address of the destination or positional information obtained from a map or through GPS.

The new data preparation unit 8 prepares new data on the basis of user input data received from the application unit 7.

When the new data preparation unit 8 receives from the application unit 7 a message to the external service 10, it transmits the message to the external service 10 and records the message in the distributive integral database 5. When the new data preparation unit 8 receives from the application unit 7 a request for making a telephone call to the external service 10, it requests the external service 10 to make a telephone call and records the telephone call in the distributive integral database 5. When the new data preparation unit 8 receives a new plan from the application unit 7, it transmits the plan to the external service 10 and records the plan in the distributive integral database 5. When the new data preparation unit 8 receives positional information from the application unit 7, it transmits the positional information to the external service 10 and records the positional information in the distributive integral database 5. When the new data preparation unit 8 receives a new contact from the application unit 7, it transmits the new contact to the external service 10 and records the new contact in the distributive integral database 5. When the new data preparation unit 8 receives from the application unit 7 a request for integration of contacts, it performs integration of contacts in the distributive integral database 5.

The new data preparation unit 8 may transmit new data to the external service 10 through the new data transmitting unit 9. The new data transmitting unit 9 receives new data from the new data preparation unit 8 and transmits the new data to the external service 10.

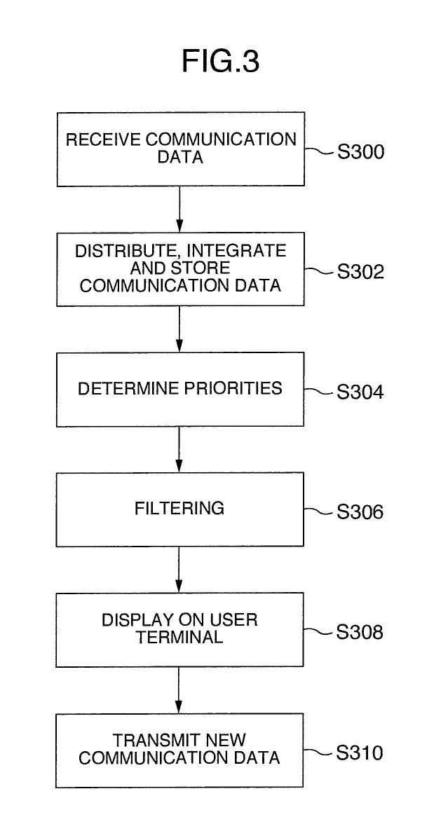

FIG. 3 is a diagram showing the flow of processing in the contact management system according to the present invention. The data acquisition unit 3 in the contact management server 2 receives communication data from the external services 10 (S300). The communication data received by the data acquisition unit 3 is distributed, integrated and stored in the distributive integral database 5 (S302). The priority determination unit 6 determines priorities for contacts on the basis of the communication data stored in the distributive integral database 5 (S304). The priority determination unit 6 filters the communication data on the basis of the priorities for the contacts determined by the priority determination unit 6 (S306). The application unit displays on the display screen of the user terminal the communication data left by filtering with the priority determination unit 6 (S308). The data preparation unit 8 prepares new communication data on the basis of an input from a user accepted by the user terminal, and transmits the new communication data through the new data transmitting unit 9 (S310).

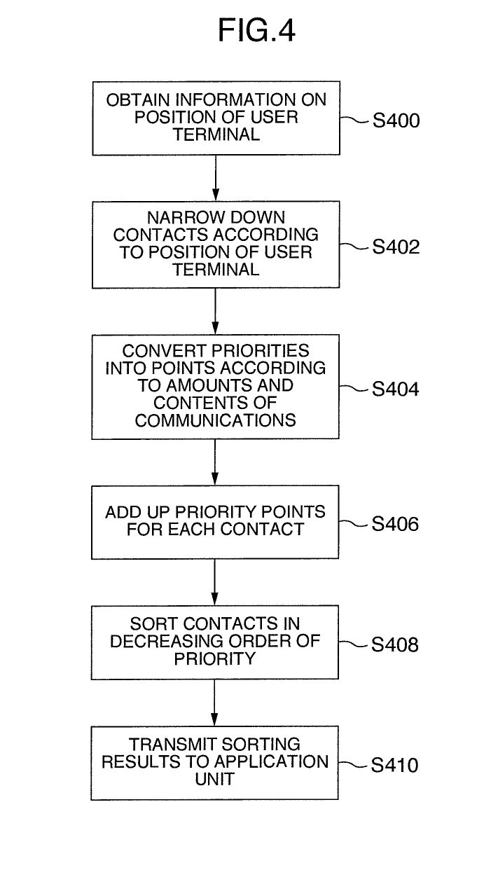

FIG. 4 is a diagram showing the flow of filtering processing and sorting processing in the priority determination unit 6.

The priority determination unit 6 obtains information on the position of the user terminal 20 (S400). Information on the position of the user terminal 20 is obtained by using the GPS function of the user terminal 20. The priority determination unit 6 narrows down contacts to be extracted in the contacts stored in the distributive integral database 5 on the basis of the information on the position of the user terminal 20 obtained in step 400 (S402). For example, if the obtained information on the position of the user terminal 20 indicates the State of California, contacts relating to the State of California are extracted. The contacts relating to the State of California include contacts with which the user communicated in the past when the user was in the State of California and contacts who sent communications to the user from the State of California.

The priority determination unit 6 converts the priorities into points on the basis of the amounts and contents of communication in the past with respect to the contacts narrowed down in step 402 (S404). The priority determination unit 6 adds up the points of the priorities converted in step 404 with respect to each contact (S406). The priority determination unit 6 sorts the contacts in decreasing order of priority point on the basis of the results of adding up in step 406 (S408). The priority determination unit 6 transmits the results of sorting in step 408 to the application unit 7 (S410).

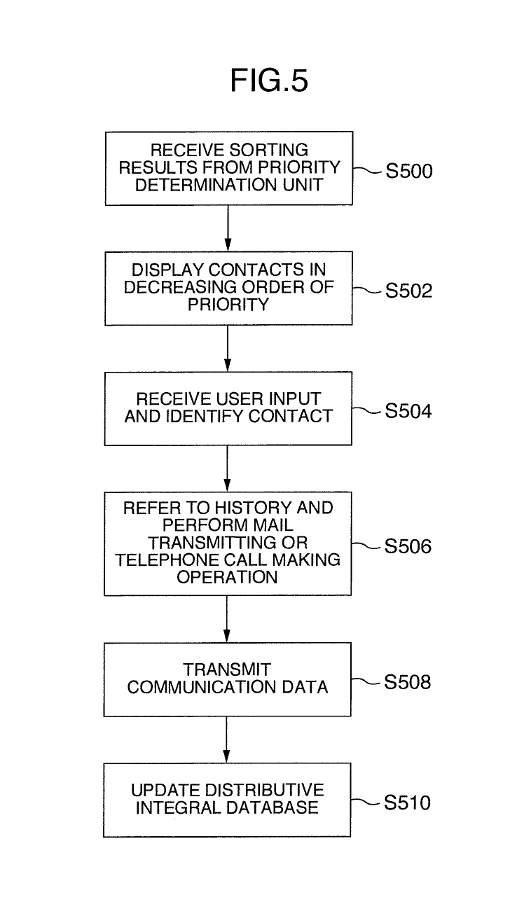

FIG. 5 is a diagram showing the flow of inbox preparation processing.

The inbox preparation unit 11 receives the sorting results from the priority determination unit (S500). The inbox preparation unit 11 displays contacts in decreasing order of priority in the inbox on the display screen of the user terminal on the basis of the sorting results received in step 500 (S502). The inbox preparation unit 11 accepts an input from the user and identifies one of the contacts with which to communicate (S504). The inbox preparation unit 11 operates on the basis of the input from the user accepted in step 504 to refer to the history of communication with the contact and transmit a piece of mail to the contact or make a telephone call to the contact (S506). The inbox preparation unit 11 transmits communication data on the operation in step 506 to the distributive integral database 5 (S508). The distributive integral database 5 is updated on the basis of the communication data transmitted in step 508 (S510). With the update of the distributive integral database, priorities for the contacts are again determined and the displays in the inbox, contact list and schedule list are also updated in real time.

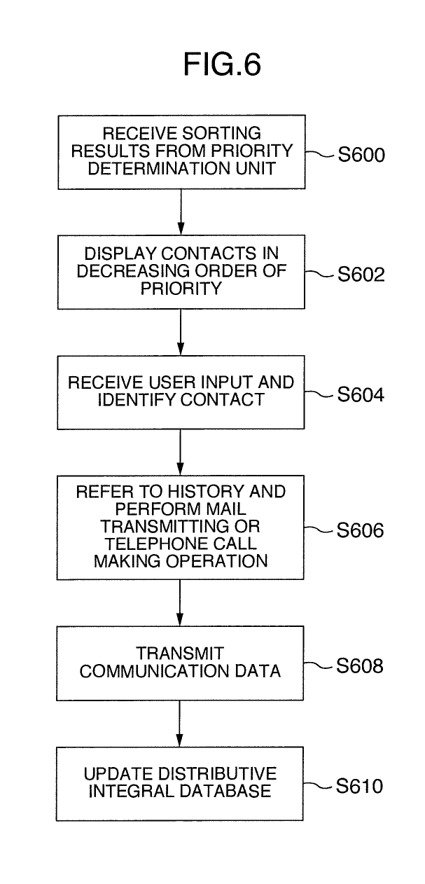

FIG. 6 is a diagram showing the flow of contact list preparation processing.

The contact list preparation unit 12 receives the sorting results from the priority determination unit (S600). The contact list preparation unit 12 displays contacts in decreasing order of priority in the contact list on the display screen of the user terminal on the basis of the sorting results received in step 600 (S602). The contact list preparation unit 12 accepts an input from the user and identifies one of the contacts with which to communicate (S604). The contact list preparation unit 12 operates on the basis of the input from the user accepted in step 604 to refer to the history of communication with the contact and transmit a piece of mail to the contact or make a telephone call to the contact (S606). The contact list preparation unit 12 transmits communication data on the operation in step 606 to the distributive integral database 5 (S608). The distributive integral database 5 is updated on the basis of the communication data transmitted in step 608 (S610). With the update of the distributive integral database, priorities for the contacts are again determined and the displays in the inbox, contact list and schedule list are also updated in real time.

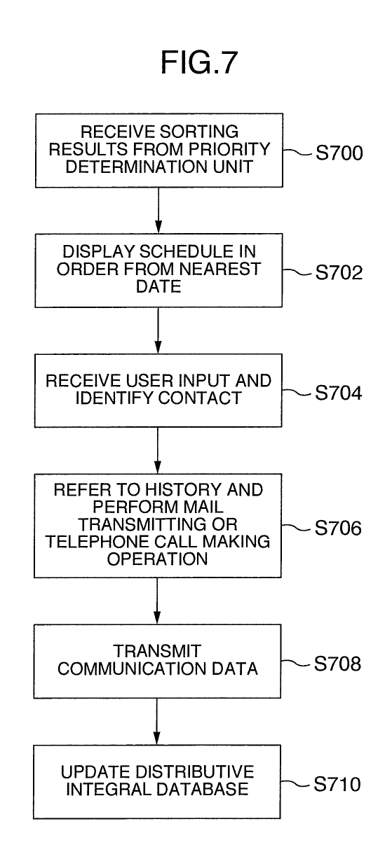

FIG. 7 is a diagram showing the flow of schedule list preparation processing.

The schedule list preparation unit 13 receives the sorting results from the priority determination unit (S700). The schedule list preparation unit 13 displays plans in order from the nearest date (S702). The schedule list preparation unit 13 may alternatively display plans in decreasing order of priority in the schedule list on the display screen of the user terminal on the basis of the sorting results received in step 700. The schedule list preparation unit 13 accepts an input from the user and identifies one of the contacts with which to communicate (S704). The schedule list preparation unit 13 operates on the basis of the input from the user accepted in step 704 to refer to the history of communication with the contact and transmit a piece of mail to the contact or make a telephone call to the contact (S706). The schedule list preparation unit 13 transmits communication data on the operation in step 706 to the distributive integral database 5 (S708). The distributive integral database 5 is updated on the basis of the communication data transmitted in step 708 (S710). With the update of the distributive integral database, priorities for the contacts are again determined and the displays in the inbox, contact list and schedule list are also updated in real time.

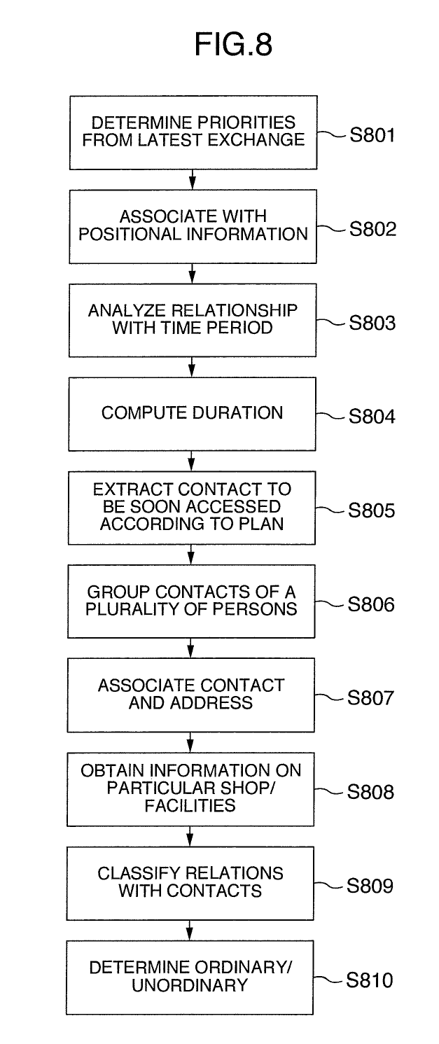

FIG. 8 is a diagram showing the flow of learning processing in the priority determination unit 6.

The priority determination unit 6 identifies a contact with a high priority as an important person from the latest occurrence of exchange and the latest frequency of exchange (S801). If the latest frequency of exchange is higher, the person can be supposed to be more important. The contact as the important person is supposed to be a contact with a higher priority. The supposition of such a contact with a higher priority is updated each time new exchange occurs. Occurrences of exchange with contacts are recorded and accumulated in the distributive integral database 5. The priority determination unit 6 determines the latest occurrence of exchange and the latest frequency of exchange on the basis of information on the occurrence of exchange recorded on the distributive integral database 5, thus enabling learning of the frequency of exchange with a particular contact.

The priority determination unit 6 obtains information on the position of the user terminal 20 at the time of communication exchange and in the background, and analyzes the relationship between a place identified from the obtained positional information and the communication data (S802). The priority determination unit 6 identifies a place having a strong relation with the user on the basis of the information on the position of the user terminal 20 at the time of communication exchange obtained by the data acquisition unit 3. An example of a place having a strong relation with the user is a place having a particularly strong relation with the user in all places relating to the user's job and private life, such as the user's home, relative's and friend's homes, a school, a place of work, a business contact's office, a shop which the user visits frequently and a hospital. The priority determination unit 6 identifies, on the basis of the positional information, the sort of data on communication performed at a place having a strong relationship with the user and the contact with which the user communicated at the place, and analyzes the relationship between the place and the communication data. This analysis enables storing and learning information which indicates with which contact the user communicated at a certain place. An example of information obtained thereby is information that when the user is in his/her place of work, he or she frequently makes a telephone call to a business-contact person A. Use of such information enables the contact corresponding to the business-contact person A to be automatically displayed in the contact list on the display screen of the user terminal 20 when the user terminal 20 is at the user's place of work.

The priority determination unit 6 obtains the communication time and analyzes the relationship between the time period during which communication has been performed and the communication data (S803). The priority determination unit 6 obtains the communication time from time information about the user terminal 20. The priority determination unit 6 can accumulate and learn information indicating when certain communication was performed or in which time period the communication was performed. This enables a contact to which a telephone signal or mail is transmitted with a high frequency, for example, in a time period from 9:00 a.m. to 10:00 a.m. to be automatically displayed in the contact list on the display screen of the user terminal 20.

The priority determination unit 6 reflects, in the degree of priority for a contact, from the information on the position of the user terminal 20, how long the user was in company with whom (S804). The priority determination unit 6 determines, from the information on the position of the user terminal 20, that a user terminal for a different user exists in a certain range from the user terminal 20, and computes the duration of the state where the user terminal for the different user has existed in the certain range from the user terminal 20. Information on the computed duration is accumulated and reflected in determination of the priority for the contact. The certain range is, for example, a range defining such a small distance between the user terminals that the users have a meeting with each other or are sitting in company with each other or in the same room or building. However, the certain range is not limited to this. The distance between the user terminals determined as being within the certain range may be changed depending on the place where the user terminals exist.

The priority determination unit 6 identifies a person with a high priority in a certain time period on a certain day from a calendar, i.e., a future schedule (S805). The priority determination unit 6 extracts contacts relating to a plan from information on a calendar accumulated in the distributive integral database 5, sets higher priorities for some of the contacts to be soon accessed according to the plan and identifies some of the contacts higher in priority rank. For example, the priorities for contacts to be soon accessed according to a plan to hold a meeting, a teleconference or the like are increased and some of the contacts higher in priority rank are identified. The priorities for the contacts are successively updated with the advancement of time and the date, thus identifying contacts with higher priorities at a certain time on a certain day.

The priority determination unit 6 automatically forms a group of contacts by referring to messages to a plurality of persons, a teleconference between the plurality of persons, communication between the plurality of persons, as to which persons the user was in company with, a plan for the group of the plurality of persons, and correspondence between groups of information on the locations of the plurality of persons (S806). In a situation where communication, such as transmission of messages to a plurality of persons or a teleconference between a plurality of persons, has been performed between a plurality of persons, the priority determination unit 6 automatically performs grouping by regarding as one group the contacts corresponding to the plurality of persons constituting the communication group. The fact that communication has been performed between the plurality of persons is determined on the basis of information including a message history and a telephone history obtained by the data acquisition unit 3. In a situation where a plan for the group of a plurality of persons has been input, the priority determination unit 6 automatically performs grouping by regarding as one group the contacts corresponding to the plurality of persons constituting the plan. The fact that the plan for the group of the plurality of persons has been input is determined on the basis of a schedule such as a calendar obtained by the data acquisition unit 3. In a situation where groups of information on the locations of a plurality of persons correspond to each other as in a case where a plurality of persons have held a meeting, the priority determination unit 6 automatically performs grouping by regarding as one group the contacts corresponding to the plurality of persons for which the corresponding positional information is provided. The fact that the groups of information on the locations of the plurality of persons correspond to each other is determined on the basis of the information on the position of the user terminal 20 obtained by the data acquisition unit 3.

The priority determination unit 6 identifies, from the information on the position of the user terminal 20, a house or an office owned by a contact who is the other party in a communication, and automatically associates the contact and the address of the contact house or office with each other only when a particular condition is satisfied (S807). The particular condition is, for example, a requirement that the user be actually communicating with the contact and have an experience of being at the contact house or office. When such a particular condition is satisfied, the priority determination unit 6 automatically associates the contact corresponding to another user with the address of the other user's house or office identified from information on the position of the other user's user terminal.

In a situation where the user visits frequently to a place made public online, e.g., a particular shop or facilities, the priority determination unit 6 determines that the place is selected with a high priority, obtains a corresponding contact and automatically adds the contact as a new contact (S808). The priority determination unit 6 counts the number of times the user visited a particular shop, facilities, or the like from information on the position of the user terminal 20. If the number of times is equal to or larger than a certain number, the priority determination unit 6 obtains information on the particular shop or facilities from information made public online Examples of the particular shop or facilities are establishments or facilities of various kinds, including establishments where foods and drinks are served, such as restaurants and tearooms, public facilities, hospitals, service facilities and amusement facilities.

The priority determination unit 6 classifies relations between the user and contacts into temporary relations (a fixed-term project, etc.) and lasting relations (family, colleagueship, etc.) (S809). The priority determination unit 6 classifies a relation with a contact by determining whether the relation is a temporary relation or a lasting relation from the number of times or frequency with which the contact was determined as a contact with a high priority in the past, the duration of such a state, or the like. For example, in the case of a temporary relation in a project over a certain time period, the priority may be increased only in the period for the project.

The priority determination unit 6 discriminates a usual procedure in which a daily routine is repeated and an unusual procedure such as a business trip or a journey from each other, and reflects this discrimination in the method of displaying contacts (S810). The priority determination unit 6 identifies an ordinary place where the user usually spends his/her time from a history of information on the position of the user terminal, and determines whether the current position of the user terminal is in the ordinary place where the user usually spends his/her time or in a different place, i.e., an unordinary place. The method of displaying contacts can be changed between the case where the current position of the user terminal is in the ordinary place and the case where the current position of the user terminal is an unordinary place.

While a smartphone, a tablet, a portable telephone, a car navigation system, a Web browser, a PC and a wearable terminal have been mentioned as examples of the user terminal according to the above-described embodiment, the user terminal is not limited to these kinds of device. A piece of next-generation hardware such as a smart home and a robot expected to be developed in future can also be used as user terminal.

It should be further understood by those skilled in the art that although the foregoing description has been made on embodiments of the invention, the invention is not limited thereto and various changes and modifications may be made without departing from the spirit of the invention and the scope of the appended claims.

1. A contact management system comprising:
a data acquisition unit which is configured to obtain communication data and information on a position of a user terminal from a plurality of external services;
a distributive integral database which is configured to integrate the communication data and the information on the position of the user terminal obtained by the data acquisition unit, and distribute the data and information with respect to contacts;
a priority determination unit which is configured to determine priorities for the contacts on the basis of the communication data and the information on the position of the user terminal accumulated in the distributive integral database; and
an application unit which is configured to present information according to the priorities determined by the priority determination unit.

2. The contact management system according to claim 1, wherein the application unit includes an inbox preparation unit which is configured to prepare an inbox on the basis of the priorities, and
wherein the inbox preparation unit displays a predetermined number of contacts having higher priorities in an inbox on a display screen of the user terminal.

3. The contact management system according to claim 1, wherein the application unit includes a contact list preparation unit which is configured to prepare a contact list on the basis of the priorities, and
wherein the contact list preparation unit displays a predetermined number of contacts having higher priorities in a contact list on a display screen of the user terminal.

4. The contact management system according to claim 1, wherein the application unit includes a schedule list preparation unit which is configured to prepare a plan list on the basis of the priorities, and
wherein the schedule list preparation unit extracts plans obtained from the plurality of external services in the communication data, and displays a predetermined number of plans in order from the nearest one of the dates of the plans.

5. The contact management system according to claim 1, wherein the priority determination unit identifies one of the contacts with a higher priority from the latest occurrence of exchange and the latest frequency of exchange.

6. The contact management system according to claim 1, wherein the priority determination unit obtains information on the position of the user terminal at the time of communication exchange and in the background, and analyzes a relationship between a place identified from the obtained positional information and the communication data.

7. The contact management system according to claim 1, wherein the priority determination unit obtains a time for communication and analyzes a relationship between a time period during which communication has been performed and the communication data.

8. The contact management system according to claim 1, wherein the priority determination unit determines that a user terminal of another user exists in a certain range from the user terminal from the information on the position of the user terminal, and calculates a duration of a state where the user terminal of the other user has existed in the certain range from the user terminal.

9. The contact management system according to claim 1, wherein the priority determination unit extracts contacts relating to a plan from calendar information accumulated in the distributive integral database and increases a priority for one of the contacts to be soon accessed according to the plan.

10. The contact management system according to claim 1, wherein in a case where communication is performed between a plurality of persons, a plan for a group of a plurality of persons is input or groups of information on the locations of a plurality of persons correspond to each other, the priority determination unit automatically performs grouping by forming one group of contacts corresponding to the plurality of persons, who perform the communication or constitute the plan in the group or for whom the corresponding positional information is provided.

11. The contact management system according to claim 1, wherein when a particular condition is satisfied, the priority determination unit automatically associates a contact corresponding to another user with an address of a house or an office owned by the other user, which address is identified from information on the position of a user terminal for the other user.

12. The contact management system according to claim 1, wherein the priority determination unit counts the number of times the user has visited a particular shop or a facility on the basis of the information on the position of the user terminal, and obtains information on the particular shop or facility from information made public online when the number of times is equal to or larger than a certain number.

13. The contact management system according to claim 1, wherein the priority determination unit classifies relations between the user and the contact into temporary relations and lasting relations on the basis of at least one of the number of times the contact has been determined as a contact with a higher priority, the frequency with which the contact has been determined as a contact with a higher priority and the duration of the state where the contact is determined as a contact with a higher priority.

14. The contact management system according to claim 1, wherein the priority determination unit identifies an ordinary place for the user from a history of information on the position of the user terminal, and determines whether or not the current position of the user terminal is in the ordinary place for the user.
